(19) United States
(12) Patent Application Publication
(10) Pub. No.: US 2018/0048635 A1
(43) Pub. Date: Feb. 15, 2018

(54) METHOD AND SYSTEM FOR A MULTIPLE PASSWORD WEB SERVICE AND MANAGEMENT DASHBOARD

(71) Applicant: Antique Books, Inc., Pittsburgh, PA (US)

(72) Inventors: Robert H. Thibadeau, Sr., Pittsburgh, PA (US); Justin D. Donnell, Verona, PA (US); Scott C. Marks, Chapel Hill, NC (US); Eugene Matthew Farrelly, Cary, NC (US)

(21) Appl. No.: 15/554,782

(22) PCT Filed: Mar. 3, 2016
(86) PCT No.: PCT/US2016/020670

§ 371 Date: Aug. 31, 2017

Related U.S. Application Data
(60) Provisional application No. 62/127,379, filed on Mar. 3, 2015.

(51) Int. Cl. H04L 29/06

(52) U.S. Cl. CPC H04L 63/083; H04L 63/10

(57) ABSTRACT

Systems and methods for a multiple password web service and management dashboard are provided. In some embodiments, a server computer providing a Proof of Knowledge (PoK) service includes one or more processors and memory containing instructions executable by the one or more processors. The server computer is thereby operable to receive an input from a client device attempting to authenticate with a Relying Party (RP) server. The server computer compares the input to each of multiple stored PoKs. In response to the input matching at least one of the stored PoKs, the server computer provides the client device access to the RP server. According to some embodiments, this enables a user to more easily remember a PoK while maintaining security and privacy.

### RELATED APPLICATIONS

This application claims the benefit of U.S. provisional patent application Ser. No. 62/127,379, filed Mar. 3, 2015, the disclosure of which is hereby incorporated herein by reference in its entirety.

### FIELD OF THE DISCLOSURE

The present disclosure relates generally to proofs of knowledge and user authentication.

### BACKGROUND

Authentication mechanisms use one or more authentication factors to control access to secured services. An authentication mechanism may require a knowledge factor (e.g., a username and a password), an ownership factor (e.g., a hardware security token), an inherence factor (e.g., a biometric identifier such as a fingerprint), or combinations thereof. The first of these is commonly referred to as proof of knowledge.

Authentication based on proof of knowledge includes a provisioning phase (e.g., enrollment) to define user knowledge and a use phase to authenticate a user that proves that knowledge. Authentication based on conventional identity management techniques provides access control to secured services by validating a username and password to demonstrate proof of knowledge. Other identity management techniques to authenticate a user employ picture passwords (rather than textual passwords) that prove that the user has knowledge of a combination of input actions together with a known image (such as, for example, a still picture, a motion picture with or without sound, a photograph). Although using a picture password increases security due to the increased complexity of the proof of knowledge, access control for authenticated users remains unchanged in existing systems.

Picture passwords can replace or supplement conventional passwords as proofs of knowledge. For example and without limitation, picture passwords can be used for web logins to access web accounts (e.g., without limitation, a bank account, a brokerage account, electronic billing, a payment system, an email account, an online music listening account, and an online video viewing account). Thus, a picture password can replace a textual password, Personal Identification Number (PIN), or pass phrase (i.e., conventional password). A username is typically associated with any proof of knowledge because it is possible to have a non-unique conventional password. Although a picture password may be more unique than other conventional passwords, a unique username may still be required by a Relying Party (RP) (e.g., the bank providing the bank account, the brokerage firm providing the brokerage account, the proprietor of the electronic billing or payment system, the provider of the online music service, or the provider of the online video service) to ensure security.

As the Internet has expanded to offer new types of information, content, and services, it has also caused a proliferation in the creation of user accounts. It is not unusual for the average user today to have tens if not hundreds of user accounts across all of the websites and Internet services that the user regularly uses. Remembering, managing, and securing these passwords has become no trivial matter.

Therefore, a way to help the user remember and manage passwords is needed.

### SUMMARY

Systems and methods for a multiple password web service and management dashboard are provided. In some embodiments, a server computer providing a Proof of Knowledge (PoK) service includes one or more processors and memory containing instructions executable by the one or more processors. The server computer is thereby operable to receive an input from a client device attempting to authenticate with a Relying Party (RP) server. The server computer compares the input to each of multiple stored PoKs. In response to the input matching at least one of the stored PoKs, the server computer provides the client device access to the RP server. According to some embodiments, this enables a user to more easily remember a PoK while maintaining security and privacy.

In some embodiments, in order to provide the client device access to the RP server, the server computer is also operable to generate an authentication token to provide access to the RP server.

In some embodiments, the input received from the client device is hashed and the stored PoKs are also hashed, and in comparing the input to each of the multiple stored PoKs, the server computer is also operable to compare the hashed input to each of the multiple stored hashed PoKs until a match is determined or there are no more stored hashed PoKs to compare.

In some embodiments, in order to provide the client device access to the RP server, the server computer is also operable to generate an authentication token to provide access to the RP server in accordance with an assigned password role associated with the PoK. In some embodiments, the assigned password role is a password role that permits full access to the RP server; a password role that permits partial access to the RP server; a password role that permits read-only access to the RP server; a password role that permits access to the RP server and causes an alert; a password role that permits the editing of the plurality of stored PoKs; a password role that permits access to the RP server and causes each other PoK of the plurality of stored PoKs to become suspended; or a password role that permits access to the RP server but prevents the upload or creation of new data.

In some embodiments, the server computer is also operable to, in response to not matching the input to at least one stored PoK, provide the client device a wrong password notification. In some embodiments, the server computer is also operable to, in response to determining that the input matches a stored PoK that has been suspended, provide the client device a wrong password notification and cause an alert.

In some embodiments, the stored PoKs include at least a text password and/or a picture password.

In some embodiments, the authentication token to provide access to the RP server indicates one or more instructions to the RP server that control access by the user of the client device to one or more services administered by the RP server. In some embodiments, the server computer is further operable to store PoKs for use with more than one RP server.

In some embodiments, the server computer is also operable to receive multiple inputs from the client device as part of a PoK provisioning process and store the multiple inputs from the client device as the multiple PoKs.

In some embodiments, the inputs received are hashed, and in order to store the multiple inputs as the multiple PoKs, the server computer is also operable to store the hashed inputs as the PoKs.

In some embodiments, as part of the multiple PoK provisioning process, the server computer is also operable to determine, based on an indication from the client device, whether each input of the inputs from the client device is acceptable as a PoK. If it is acceptable, the server computer proceeds to store that input as one of the PoKs. If not, the server computer refrains from storing that input as one of the PoKs.

In some embodiments, activating the multiple PoK provisioning process occurs prior to receiving the input from the client device attempting to authenticate with an RP server. In some embodiments, activating the multiple PoK provisioning process occurs after providing the client device access to the RP server. In some embodiments, activating the multiple PoK provisioning process occurs in response to receiving a request from the client device to perform password management. In some embodiments, in response to receiving the request from the client device to perform password management, the server computer is also operable to send to the client device a status of each of the PoKs stored. The status includes one or more of a visual reminder of the PoK; a hint for the PoK; a number of successful uses of the PoK; an indication of the last successful use of the PoK; a password role assigned to the PoK; an indication of the state of the PoK; and an indication of the strength of the PoK.

In some embodiments, a method of operating a server computer providing a PoK service includes receiving an input from a client device attempting to authenticate with a RP server; comparing the input to each of multiple stored PoKs; and, in response to the input matching at least one of the stored PoKs, providing the client device access to the RP server.

Those skilled in the art will appreciate the scope of the present disclosure and realize additional aspects thereof after reading the following detailed description of the preferred embodiments in association with the accompanying drawing figures.

### BRIEF DESCRIPTION OF THE DRAWING FIGURES

The accompanying drawing figures incorporated in and forming a part of this specification illustrate several aspects of the disclosure, and together with the description serve to explain the principles of the disclosure.

FIG. 1 illustrates an example of an architecture designed for user authentication;

FIG. 2 illustrates a method of authenticating a user in an architecture such as shown in FIG. 1;

FIG. 3 illustrates a method of authenticating a user using one of multiple passwords, according to some embodiments of the present disclosure;

FIG. 4 illustrates additional details of authenticating a user using one of multiple passwords, according to some embodiments of the present disclosure;

FIG. 5 illustrates the provisioning of multiple passwords, according to some embodiments of the present disclosure;

FIG. 6 illustrates a method of provisioning multiple passwords, according to some embodiments of the present disclosure;

FIG. 7 illustrates a password management dashboard, according to some embodiments of the present disclosure;

FIG. 8 illustrates a method of authenticating a user to access the password management dashboard, according to some embodiments of the present disclosure; and

FIG. 9 illustrates the hardware components of various systems, according to some embodiments of the present disclosure.

### DETAILED DESCRIPTION

The embodiments set forth below represent the necessary information to enable those skilled in the art to practice the embodiments and illustrate the best mode of practicing the embodiments. Upon reading the following description in light of the accompanying drawing figures, those skilled in the art will understand the concepts of the disclosure and will recognize applications of these concepts not particularly addressed herein. It should be understood that these concepts and applications fall within the scope of the disclosure and the accompanying claims.

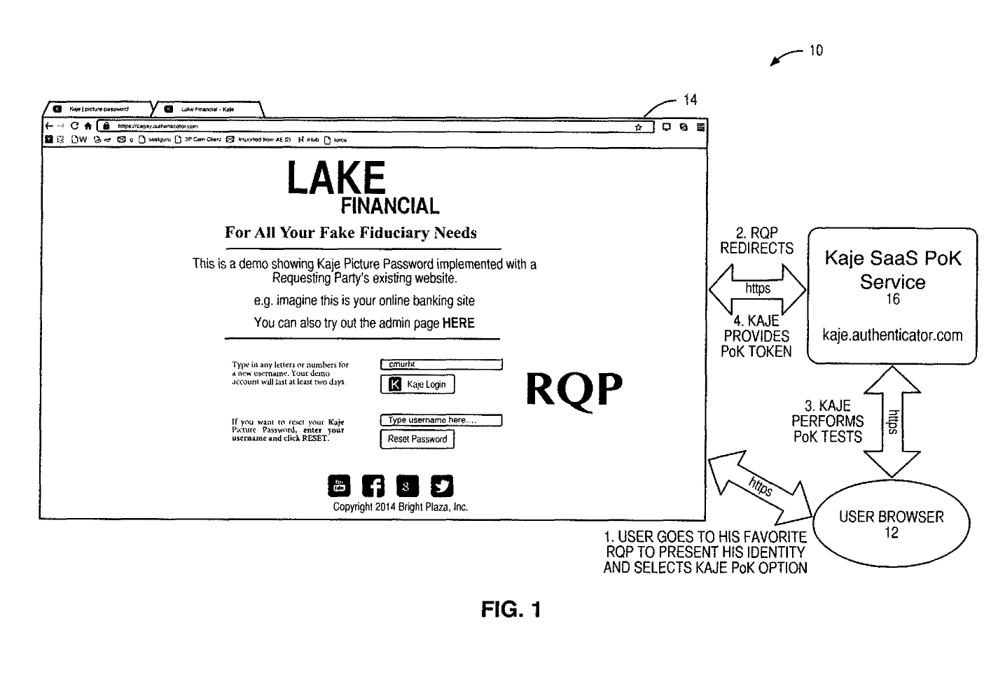

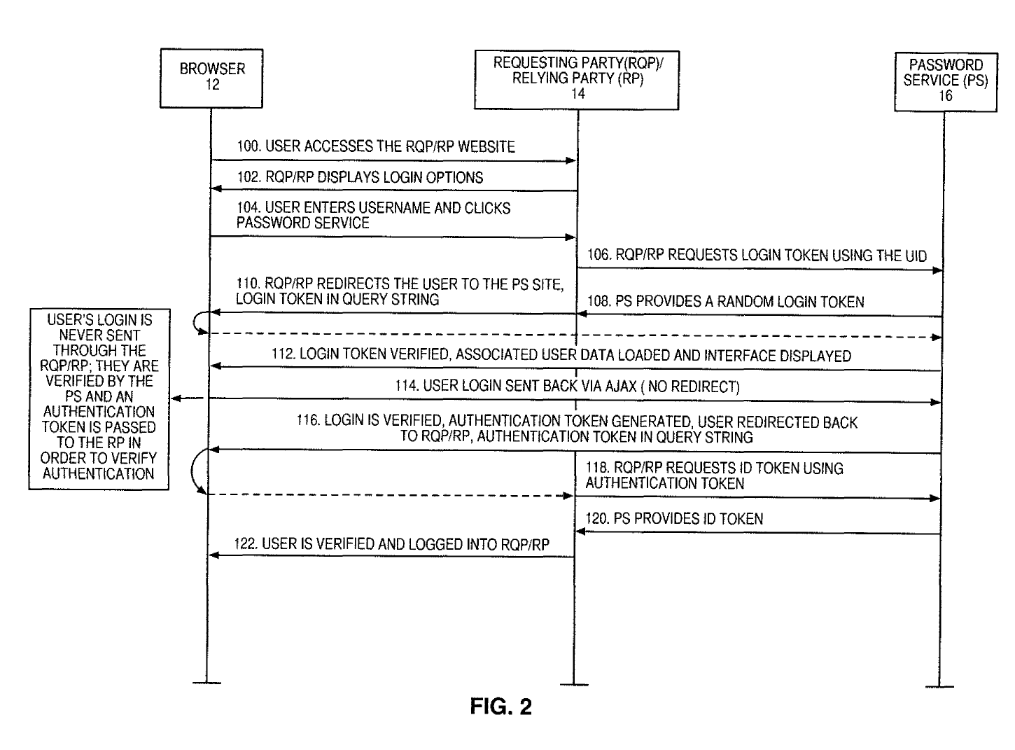

An example of an architecture designed to offer better security for user authentication is described in International Patent Publication Number WO 2014/165431 entitled “Method and System Providing a Picture Password Proof of Knowledge”, which is incorporated herein by reference in its entirety and which is illustrated at a high level in FIG. 1 and a more detailed level in FIG. 2. In FIG. 1, an example system 10 includes a user browser 12 (also referred to herein more generally as a client device 12) accessing a website (Lakeland Financial, for illustrative purposes) identified as a Requesting Party (RQP) or sometimes a Relying Party (RP) server 14 in that it represents a website or service that relies on a username and Proof of Knowledge (PoK) in order to provide the user with access to the services and requests the PoK from the authentication service or password service 16. Examples of the RQP/RP include, but are not limited to, email providers, online banks, online music listening services, online video viewing services, etc. As shown in FIG. 1, the RP 14 redirects the user to a Kaje Software as a Service (SaaS) PoK service 16, also referred to herein more generally as a Password Service (PS) 16, that provides authentication services as described below.

FIG. 2 illustrates a method of authenticating a user in an architecture such as shown in FIG. 1. As shown in FIG. 2, the example system 10 includes a client device (browser 12), a RQP/RP server 14, and a PS 16. While the client device is discussed herein as a browser 12, the current disclosure is not limited thereto. The client device could interact with the other components of the system 10 in any other suitable manner. Also, the PS 16 is also referred to herein as a PoK server or as a server computer providing a PoK service. In some embodiments, a single server may actually be a group of servers acting in coordination as if they were one server.

As shown in FIG. 2, a user at the browser 12 accesses a website at the RQP/RP server 14 (step 100). The RQP/RP server 14 displays login options (step 102). In this example embodiment, the user at the browser 12 enters a username and clicks (or otherwise selects) a password service (step 104). The RQP/RP server 14 requests a login token using a User ID (UID) associated with the username (step 106). The PS 16 provides a random login token to the RQP/RP server 14 (step 108). In some embodiments, the login token includes a time-out period associated with how long the user will be allowed to provide his/her proof of knowledge to the PS 16. The login token may also contain a salt associated with the UID. The RQP/RP server 14 redirects the user's browser 12 to the PS site with the login token in the query string (step 110).

The PS 16 verifies the login token (making sure it is still valid, etc.) and displays any necessary user data or interfaces (step 112). The user login (i.e. password) is sent back to the PS 16 via AJAX (or similar asynchronous communication technique) with no redirect (step 114). Since the user then interacts directly with the PS 16, the user's login is never sent through the RQP/RP server 14. In some embodiments, the password or PoK input is hashed or otherwise obfuscated before sending to the PS 16. In this case, the PS 16 is denied access to the plaintext PoK. In other embodiments, the password or PoK input is further hashed on the server for enhanced security. In some embodiments, this server-side hashing of the password or PoK input is performed by the PS 16 before the PS 16 performs any further operations on the password or PoK input (such as verifying the login by comparing the password or PoK input to stored PoKs to determine a match).

If the login is verified, the PS 16 generates an authentication token and the user's browser 12 is redirected back to the RQP/RP server 14 with the authentication token in the query string (step 116). The RQP/RP server 14 may then request an ID token from the PS 16 using the authentication token (step 118). The PS 16 provides the ID token associated with the authentication token (step 120) and the user is verified and logged into the RQP/RP server 14 (step 122).

As the Internet has expanded to offer new types of information, content, and services, it has also caused a proliferation in the creation of user accounts. It is not unusual for the average user today to have tens if not hundreds of user accounts across all of the websites and Internet services that the user regularly uses. Remembering, managing, and securing these passwords has become no trivial matter.

This disclosure describes the concept of allowing the user to create multiple passwords for use with a particular website. Passwords may be traditional text based passwords, picture passwords as described in U.S. Pat. No. 8,813,183 entitled “Method and System for Processor or Web Logon,” incorporated herein by reference in its entirety, or any other type of PoK.

Systems and methods for a multiple password web service and management dashboard are provided. In some embodiments, a server computer providing a PoK service includes one or more processors and memory containing instructions executable by the one or more processors. The server computer is thereby operable to receive an input from a client device attempting to authenticate with an RP server. The server computer compares the input to each of multiple stored PoKs. If the input matches at least one of the multiple stored PoKs, the server computer provides the client device access to the RP server. According to some embodiments, this enables a user to more easily remember a PoK while maintaining security and privacy.

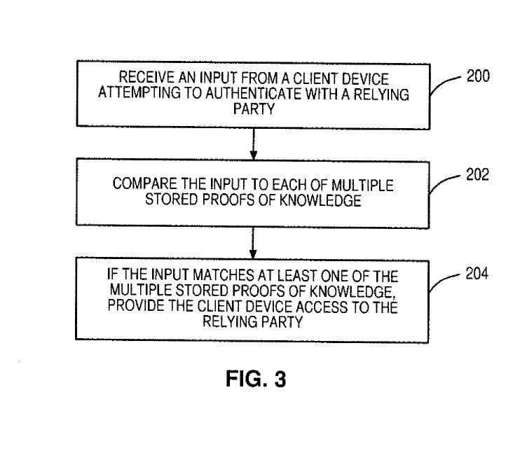

FIG. 3 illustrates a method of authenticating a user using one of multiple passwords, according to some embodiments of the present disclosure. A server computer providing a PoK service (referred to herein as PS 16) receives an input from a client device (referred to herein as a browser 12, but the current disclosure is not limited thereto) attempting to authenticate with an RP (referred to herein as RQP/RP 14) (step 200). The PS 16 compares the input to each of multiple stored PoKs (step 202). If the input matches at least one of the multiple stored PoKs, the PS 16 provides the browser 12 access to the RQP/RP 14 (step 204).

In some embodiments, each password required would meet the minimum strength requirements dictated by the RQP/RP 14, but once provisioned or created, the use of any one particular password would grant the user access to the services of the RQP/RP 14. In this manner, the multiple password feature relaxes the requirements for what the user must remember in order to access a particular RP without necessarily compromising the security.

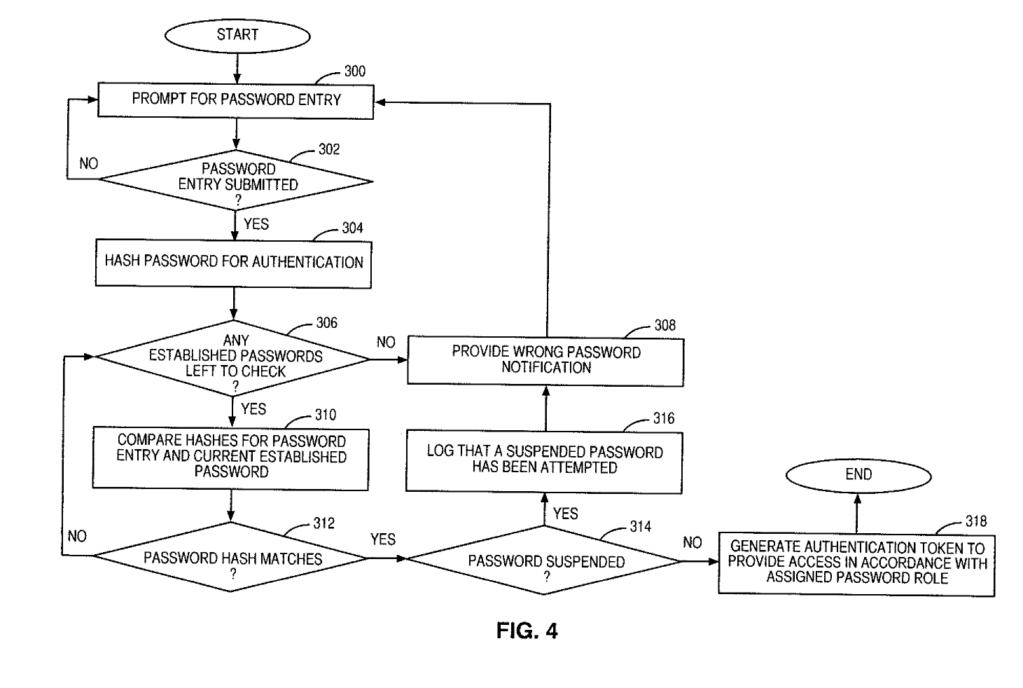

FIG. 4 illustrates additional details of authenticating a user using one of multiple passwords, according to some embodiments of the present disclosure. First, the browser 12 prompts for a password (or any other PoK) entry (step 300). If no password entry is submitted, the browser 12 again prompts for password entry (step 302). If a password is submitted, the browser 12 hashes the password for authentication (step 304). The hashed password is then sent from the Browser 12 to the PS 16 (as in step 114 of FIG. 2). In some embodiments, this might not be done, or the password may be transformed in some other way.

The PS 16 checks if there are any established passwords (or stored PoKs) left to check (step 306). If not, the PS 16 provides a wrong password notification (step 308). If there is an established or stored password left to check, the PS 16 compares the hashes for the password entry and the current established password that is being checked (step 310) to see if there is a match (step 312). If the password hashes do not match, the PS 16 returns to step 306 to again check if any established passwords are left to check.

If the password hashes match, the PS 16 then checks if the matched password is currently suspended (step 314). As used herein, a suspended password is still maintained in the system for various reasons, but this password does not provide access to the RQP/RP 14. In some embodiments, a suspended password may be a password that is suspected of being used fraudulently or otherwise being accessible to unwanted parties. In such cases, the PS 16 may log that a suspended password has been attempted and may even generate an alert (step 316). In some embodiments, the PS 16 still provides the wrong password notification as in step 308 since access should not be granted, but it may not be advisable to alert the user of the suspended password that the password is suspended.

If the password is not suspended, the PS 16 generates an authentication token (as in step 116 of FIG. 2) to provide access in accordance with an assigned password role (step 318). Assigned password roles are discussed in more detail below.

Password Tokens & Roles

As indicated in step 116 of FIG. 2, upon the submission of a successful login by the browser 12, the PS 16 redirects the browser 12 to the RQP/RP 14 with an authentication token from the PS 16 in the query string. In some embodiments, the authentication tokens are used to set the role or type of access that the password grants to the services of the RQP/RP 14. A successful login gets only one authentication token and corresponding role; authentication tokens and corresponding roles cannot be additive or mixed. Example tokens and roles include, but are not limited to:
Login-FullAccess: This role is the usual login. It grants full access to the services of the RQP/RP 14.
Login-PartialAccess: This role grants partial access to the services of the RQP/RP 14 (provided that the RQP/RP 14 permits partial access)
Login-ReadOnly: This role grants read-only access to the services of the RQP/RP 14 (provided that the RQP permits read-only access)
Login-Alert: This role logs in but requests an alert to be sent (again, only if permitted by RQP). In some embodiments, this may be the same as Login-ReadOnly, with the only difference being that an alert is sent to warn that the RQP/RP 14 is being accessed by a browser 12 whose user may be under duress. In another embodiment, to ensure the safety of the user, this role grants access to simulated services of the RQP/RP 14 (i.e. the role appears to grant full access to the services of the RQP/RP 14, but it only offers access to a simulated environment with no real transactions).
Edit-Passwords: This role allows editing all passwords, including the one used for this particular role. A password can be locally added, suspended, or deleted (suspend means the editor can bring it back by unsuspending it).
Login-Bump-FullAccess: This role grants full access to the services of the RQP/RP 14 but suspends all other logins/passwords/PoKs except edit and other bump passwords. (This is the equivalent of the person turning off all the other passwords because he fears one of them was stolen).
Login-NoUpload: This role grants full access to the services of the RQP/RP 14 but prevents the uploading or creating of new data. This could be useful for services where uploads are prevented for compliance with the Children's Online Privacy Protection Act (COPPA) Provisions, such as such as Privacy Vaults Online (PRIVO), etc.

In some embodiments, these roles may not be defined or used. In such cases, the default can be Login-FullAccess since this is essentially a usual login. Also, in some embodiments, any provisioned text password may be made into an alert password (such as in times of duress by the user) by simply prefixing a “safe” word to the provisioned password. For example, if the user's password is “abcd1234”, then the user could make that password an alert password simply by prefixing a safe word, such as “help” to their password at the browser 12. Thus, in a time of duress, the user need not remember a specific alert password, but can manually make an alert password by combining the safe word with the password the user can remember, e.g., “helpabcd1234.” Text passwords would be parsed for the safe word first. If recognized, then communications with the RQP/RP 14, in addition to the process outlined in FIG. 2, would reflect that the password has been promoted to an alert state so that the RQP/RP 14 could alert authorities. However, the password would be otherwise normally hashed as normal for authentication.

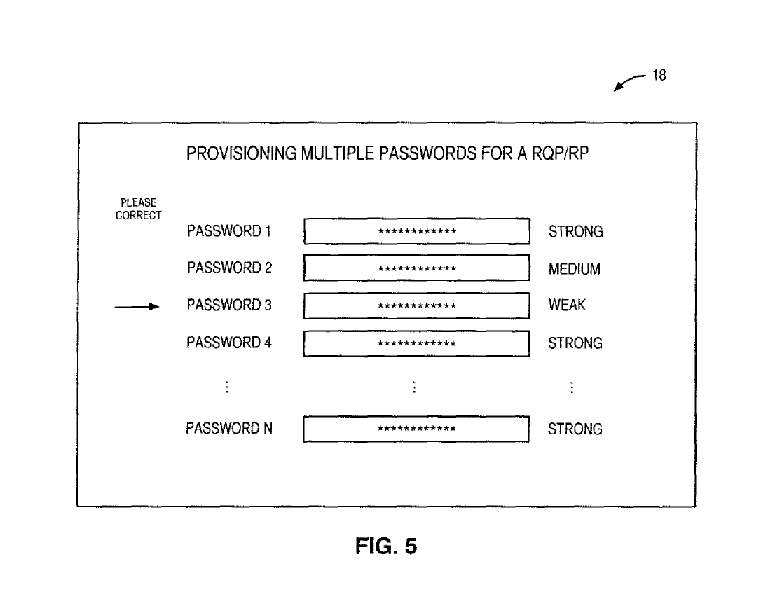

FIG. 5 illustrates the provisioning of multiple passwords for an RQP/RP 14, according to some embodiments of the present disclosure. In this figure, a multiple PoK provisioning process 18 is shown with text passwords, but the current disclosure is not limited thereto. Up to N passwords are shown where N may be system defined based on information from the RQP/RP 14 or configurable by the user. The system may indicate a strength of the passwords as is illustrated by Password 1 being indicated as strong while Password 3 is indicated as a weak password. In this example, the multiple PoK provisioning process 18 is prompting the user to please correct the weak password, but other embodiments do not require such correction.

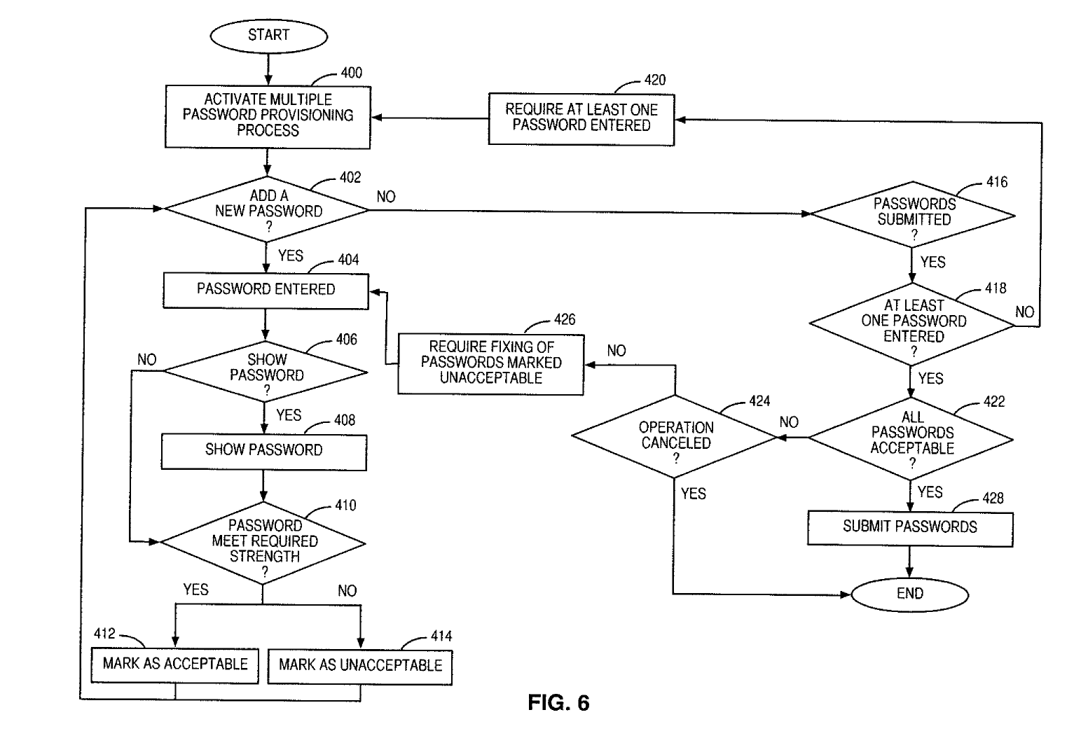

FIG. 6 illustrates a method of provisioning multiple passwords, according to some embodiments of the present disclosure. The multiple password provisioning process 18 is first activated for a particular RQP/RP 14 (step 400). In this particular embodiment, the provisioning takes place on the browser 12 with the provisioned passwords ultimately submitted to the PS 16 for use with the particular RQP/RP 14. In alternative embodiments, the provisioning could take place on the browser 12, RQP/RP 14, PS 16 or any combination therein. The browser 12 first checks if a new password or PoK has been added (step 402). In some embodiments, this could take the form of adding a new row as shown in FIG. 5. The password is then entered (step 404). In some embodiments, there may be an option to show the password in the browser 12 when it is entered. If this option is activated (step 406), the password is shown (step 408). Otherwise, the password will be hidden in some way to prevent accidental disclosure. The browser 12 then checks if the password meets the required strength (step 410). In some embodiments, the browser 12 may receive settings from the RQP/RP 14 that define password strengths that are acceptable to the RQP/RP 14. Depending on the strength of the password, it is marked as acceptable (step 412) or marked as unacceptable (step 414). The process returns to step 402 to determine if another password has been added.

If no new password is added or if a maximum number of passwords has already been entered, the browser 12 checks to see if the passwords are to be submitted (step 416) and checks if at least one password is entered (step 418). If no passwords are entered, the browser 12 indicates that at least one password is required to be entered (step 420) and the multiple password provisioning process 18 is restarted (step 400).

If at least one password is entered, the browser 12 checks if all of the passwords are marked as acceptable (step 422). If not, the browser 12 then checks to see that the password provisioning process or operation has not been canceled (step 424). If not, the browser 12 indicates that the passwords marked as unacceptable must be fixed (step 426) and allows for passwords to be entered again (step 404). If the password provisioning process or operation has been canceled, then the process ends. Once all passwords are acceptable, the browser 12 submits the passwords to the PS 16 for use with the RQP/RP 14 (step 428). In some embodiments, the passwords may be hashed by the browser 12 before submission to the PS 16.

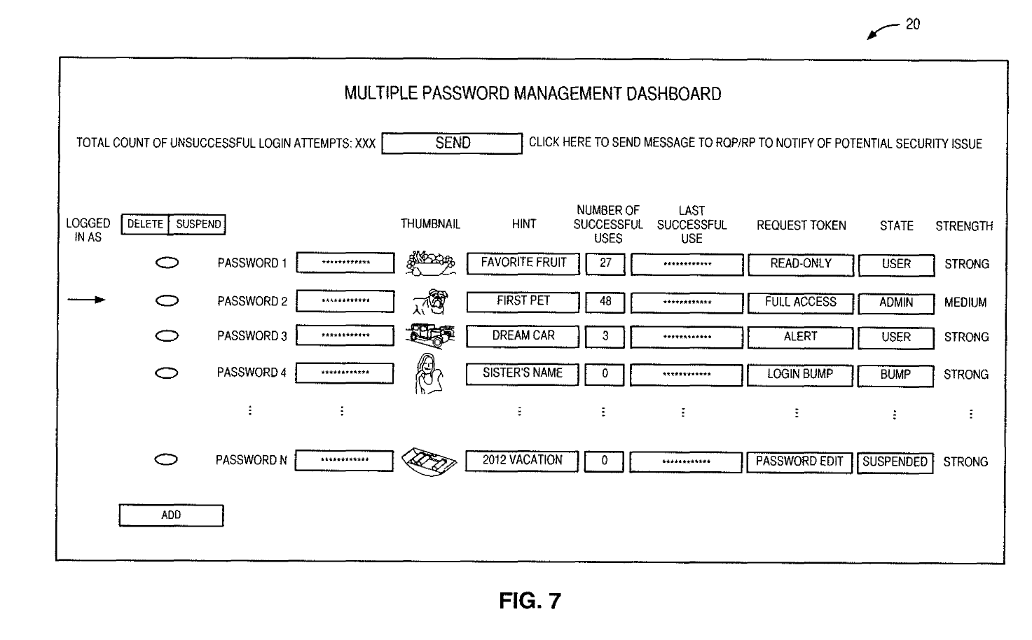

This disclosure further describes a Password Management Dashboard which the user may employ to manage and select different attributes for each of the passwords that have been created in the multiple password service. An example interface is shown in FIG. 7 which illustrates Password Management Dashboard 20, according to some embodiments of the present disclosure. While FIG. 7 shows text passwords, the current disclosure is not limited thereto. The Password Management Dashboard 20 may show text passwords, picture passwords, or any combination of the two.

The following is a description of some of the fields and features that Password Management Dashboard 20 may have, depending on the embodiment and implementation details. In some embodiments, the Password Management Dashboard 20 will have a simple interface in a default mode and an optional advanced mode with additional capabilities.

Password Management Dashboard for Multiple Text Passwords

Fields:

Actions on passwords—Add, Delete, or Suspend (passwords may be added, deleted, or suspended). In some embodiments, a radio button or other interface mechanism may be used to allow multiple passwords to have the same action, e.g., suspend the selected passwords). In other embodiments, the interface may support the ability to easily select all passwords so that an action can be applied to all of them at the same time.

Password List—The Password Management Dashboard 20 then has a separate row for each password. The default interface will show a certain number of passwords (up to N passwords). In some embodiments, the Password Management Dashboard 20 supports different interface controls (pagination, scrolling, etc) to allow for as many passwords that have been defined.

Unsuccessful Login Counter—The Password Management Dashboard 20 has a field for the total count of unsuccessful tries. In some embodiments, there is also a button or a mechanism whereby the RP 14 can be sent a message if the user sees problem of security.

Also in the Password Management Dashboard 20, every password has:
[Identifier]->Password 1, Password 2, etc.
[PoK Hash/Password/Picture Password]
[picture]-->uploaded or provided, unique to that password. (Can't upload same pic for two passwords)
[hint?]—under management, could be used to identify the password without showing the password
[total count of successful uses]
[date and time of last successful use]
[Password request token : login, read-only, alert, no-upload . . . ]
[password state : user, admin, bump, . . . ]—This links the role to the password and the request token. In some embodiments, it also delineates a state for the password itself (such as if the password is suspended). In some embodiments, one or more admin passwords may turn off admin capability of the user. In other embodiments, bump passwords may suspend all other passwords. Setting an admin or a bump is a significant event that generally requires the user to know what he is doing.

Password Management Dashboard for Multiple Picture Passwords

Password List—The Password Management Dashboard 20 for use with picture passwords also has a separate row for each password. The default interface will show a certain number of passwords (up to N passwords). In some embodiments, the Password Management Dashboard 20 supports different interface controls (pagination, scrolling, etc) to allow for as many passwords that have been defined Unsuccessful Login Counter—The Password Management Dashboard 20 has a field for the total count of unsuccessful tries. In some embodiments, there is also a button or a mechanism whereby the RP 14 can be sent a message if the user sees problem of security.

Also in the Password Management Dashboard 20, every password has:
[Identifier]->Password 1, Password 2, etc.
[PoK Hash/Password/Picture Password] (possible to add more than one password to this picture)
[password request token: login, read-only, alert, no-upload . . . ], “alert” could be configurable with different side effects
[password edit state: user, admin, bump, . . . ]—one or more admins turns off admin capability of the user—maybe bump specialized to just be able to bump, setting an admin or a bump becomes a major event for the user to know what he is doing.
[picture]-->uploaded or provided, unique to that password. (Can't upload same pic for two passwords)
[hint?]—under management, could be used to identify the password without showing the password
[total count of successful uses]
[date and time of last successful use]
[gives the option of requiring both a text password and picture password, or one, or the other]

In addition, each password may retain additional information such as a thumbnail picture. In some embodiments, this thumbnail enables a person to remember or identify a particular password. In some embodiments, this image is similar to a site key where the displayed image was earlier configured. If the user does not recognize the image, the user may question the validity of the site as it may be an attempted man-in-the-middle attack. Each password has a picture. In some embodiments, the PS 16 may show all the thumbnails to let the user remember which passwords would work for this RQP/RP 14. This makes use of human recognition memory. Also, in some embodiments, this also means the user can manage a mix of text and picture passwords all in exactly the same way. As described above, the PoKs may include a text password, a picture password, or some combination of the two. For instance, a picture password may include a text box that takes a text password too.

Also, the user can look at the pictures and see the type of password and its state (if active or suspended). The user can also see the strength that has been saved for the password. The history of use of each password (count of successes for each and for all passwords the total number of failed) may also be displayed. If, for example, one password should not be used (the person is treating it as a backup or to catch a thief, the user can see it if it is used, then hit “bump” to stop the use until the user can determine out what is going on.)

Additional features may include an option to show/hide the passwords on the provisioning screen. On login, the RQP can control it.

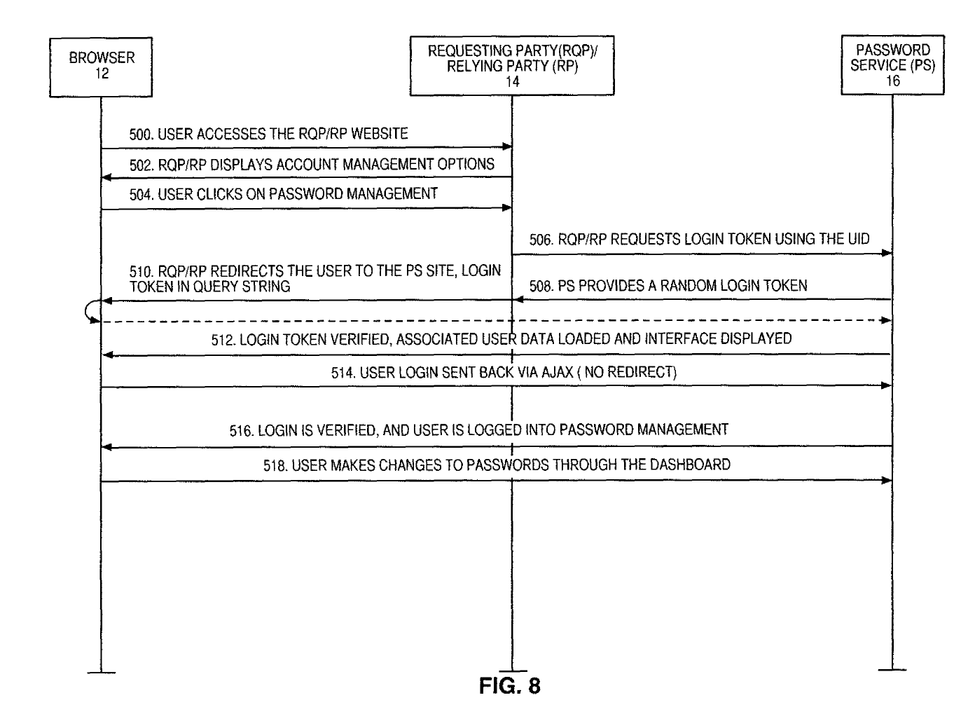

Due to the separation of usernames and passwords outlined in the architecture described above, the user might not be able to simply change a password on the RQP/RP 14 as is the case with most services today. Re-authentication with the password service will be required and then passwords may be directly managed by the user on the PS 16 through the Password Management Dashboard 20, as illustrated in FIG. 8 which illustrates a method of authenticating a user to access the password management dashboard, according to some embodiments of the present disclosure.

Branding (i.e. look and feel) of the Password Management site could be made to look like that of the RQP/RP site so that it appears to be a seamless integration. As shown in FIG. 8, a user at the browser 12 accesses a website at the RQP/RP server 14 (step 500). The RQP/RP server 14 returns account management options for display in the browser 12 (step 502). In this example embodiment, the user at the browser 12 clicks on (or otherwise selects) a password management option (step 504). The RQP/RP server 14 requests a login token using a UID associated with the username (step 506). The PS 16 provides a random login token to the RQP/RP server 14 (step 508). In some embodiments, the login token includes a time-out period associated with how long the user will be allowed to provide his/her proof of knowledge to the PS 16. The login token may also contain a salt associated with the UID. The RQP/RP server 14 redirects the user's browser 12 to the PS site with the login token in the query string (step 510).

The PS 16 verifies the login token (making sure it is still valid, etc.) and displays any necessary user data or interfaces (step 512). The user login is sent back to the PS 16 via AJAX (or similar asynchronous communication technique) with no redirect (step 514). Since the user then interacts directly with the PS 16, the user's login is never sent through the RQP/RP server 14. In some embodiments, the password or PoK input is hashed or otherwise obfuscated before sending to the PS 16. In this case, the PS 16 is denied access to the plaintext PoK.

If the login is verified, the PS 16 generates an authentication token and the user's browser 12 and the user is logged into the password management system (step 516). The user then makes changes to passwords through the dashboard as discussed above (step 518).

Note also that due to the different edit states assigned to passwords, it may be necessary to offer an option at login to allow the user to promote a simple “user” password to allow modification of password upon authentication. Of course, login with an “admin” password would automatically grant the permission to modify passwords.

In an alternative embodiment, it would be possible for the PS 16 to provision an additional token, a password management token, upon successful login that would allow the user to easily access password management features during the same login session without requiring re-authentication as described above.

In some embodiments, in addition to offering the Password Management Dashboard 20, the PS 16 also offers an Advanced Capability Dashboard. Advanced Capability (AC) refers to proving a cognitive state of a user. Such Advanced Capabilities are described in U.S. Provisional No. 62/006,472 entitled “Advanced Proofs of Knowledge for the Web” and in the non-confidential pre-publication version of an academic paper submitted to the IEEE entitled “Completely Refactoring User Authentication,” both of which are incorporated herein by reference in their entirety.

AC Class PoK may include various options. By default, one screen may be for the ID PoK that proves the user's ID, followed by the AC PoK that proves a cognitive state. In some embodiments, the AC PoK is embedded in the ID PoK. Provisioning the AC PoK may include using an image editor such as Photoshop to bring up an image of the test. The editor may bring up the grid layer and adjust the answers to do the multiple choice selection. The user may save the adjusted image, and upload to the PS 16 as the test page. The PS 16 may also bring up a JavaScript tool (or other tool) that performs a similar function.

What tokens to associate with what answers in the multiple choice may be decided by the user. A user might be able to set a timeout for an AC PoK in one embodiment. Also, the user or client device may report back the time taken to complete AC PoK and the PS 16 may judge whether the time requirement was satisfied.

In some embodiments, the AC PoK Dashboard may be separate but available from the ID PoK Dashboard (possibly popup or tabs). The AC PoK may also include a movie, animation, and/or sound.

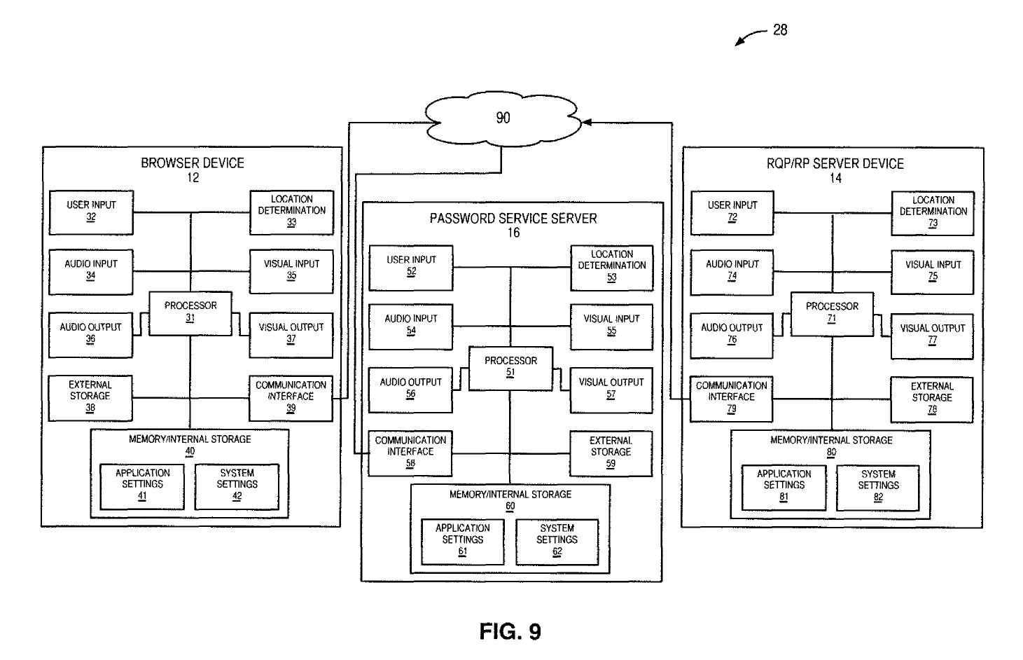

FIG. 9 illustrates the hardware components of various systems, according to some embodiments of the present disclosure. The system 10 includes a browser device 12 which may correspond to any browser or client device discussed above. Browser device 12 is shown as including multiple components. In some embodiments, only a subset of these components will be included. Browser device 12 includes one or more processors 31, a user input 32, a location determination 33, an audio input 34, a visual input 35, an audio output 36, a visual output 37, an external storage 38, and a communication interface 39. Browser device 12 also includes a memory/internal storage 40 which may include application settings 41 and system settings 42. In some embodiments, the memory 40 may contain instructions executable by the one or more processors 31 whereby the browser device 12 is operable to perform any steps described above.

The system 10 also includes a PS server 16 which may correspond to any PS or server computer providing a PoK service as discussed above. PS server 16 is shown as including multiple components. In some embodiments, only a subset of these components will be included. PS server 16 includes one or more processors 51, a user input 52, a location determination 53, an audio input 54, a visual input 55, an audio output 56, a visual output 57, an external storage 58, and a communication interface 59. PS server 16 also includes a memory/internal storage 60 which may include application settings 61 and system settings 62. In some embodiments, the memory 60 may contain instructions executable by the one or more processors 51 whereby the PS server 16 is operable to perform any steps described above.

The system 10 also includes a RQP/RP server 14 which may correspond to any RP or RQP/RP server as discussed above. RQP/RP server 14 is shown as including multiple components. In some embodiments, only a subset of these components will be included. RQP/RP server 14 includes one or more processors 71, a user input 72, a location determination 73, an audio input 74, a visual input 75, an audio output 76, a visual output 77, an external storage 78, and a communication interface 79. RQP/RP server 70 also includes a memory/internal storage 80 which may include application settings 81 and system settings 82. In some embodiments, the memory 80 may contain instructions executable by the one or more processors 14 whereby the RQP/RP server 70 is operable to perform any steps described above. The system 10 also includes a network 90 to facilitate communication between the various components.

Those skilled in the art will recognize improvements and modifications to the preferred embodiments of the present disclosure. All such improvements and modifications are considered within the scope of the concepts disclosed herein and the claims that follow.

What is claimed is:

1. A server computer providing a Proof of Knowledge (PoK) service, comprising:
one or more processors; and
memory containing instructions executable by the one or more processors whereby the server computer is operable to:
receive an input from a client device attempting to authenticate with a Relying Party (RP) server;
compare the input to each of a plurality of stored PoKs; and
in response to the input matching at least one of the plurality of stored PoKs, provide the client device access to the RP server.

2. The server computer of claim 1 wherein, in order to provide the client device access to the RP server, the server computer is further operable to generate an authentication token to provide access to the RP server.

3. The server computer of any of claims 1 through 2 wherein, the input from the client device is hashed and the stored PoKs are also hashed and in comparing the input to each of the plurality of stored PoKs, the server computer is further operable to:
compare the hashed input to each of the plurality of stored hashed PoKs until a match is determined or there are no more stored hashed PoKs to compare.

4. The server computer of any of claims 1 through 3 wherein, in order to provide the client device access to the RP server, the server computer is further operable to generate the authentication token to provide access to the RP server in accordance with an assigned password role associated with the one of the plurality of stored PoKs.

5. The server computer of claim 4 wherein the assigned password role associated with the one of the plurality of stored PoKs is chosen from the group consisting of:
a password role that permits full access to the RP server;
a password role that permits partial access to the RP server;
a password role that permits read-only access to the RP server;
a password role that permits access to the RP server and causes an alert;
a password role that permits the editing of the plurality of stored PoKs;
a password role that permits access to the RP server and causes each other PoK of the plurality of stored PoKs to become suspended; and
a password role that permits access to the RP server but prevents the upload or creation of new data.

6. The server computer of any of claims 1 through 5 further operable to, in response to not matching the input to the at least one stored PoK, provide the client device a wrong password notification.

7. The server computer of any of claims 1 through 6 further operable to, in response to determining that the input matches a stored PoK that has been suspended, provide the client device the wrong password notification and cause the alert.

8. The server computer of any of claims 1 through 7 wherein the plurality of stored PoKs includes at least one of the group consisting of a text password and a picture password.

9. The server computer of any of claims 4 through 8 wherein the authentication token to provide access to the RP server indicates one or more instructions to the RP server that control access by a user of the client device to one or more services administered by the RP server.

10. The server computer of any of claims 1 through 9 wherein the server computer is further operable to store PoKs for use with more than one RP server.

11. The server computer of any of claims 1 through 10 wherein the server computer is further operable to:
receive a plurality of inputs from the client device as part of a multiple PoK provisioning process; and
store the plurality of inputs from the client device as the plurality of PoKs.

12. The server computer of claim 11 wherein the inputs received are hashed and in order to store the plurality of inputs as the plurality of PoKs, the server computer is further operable to store the hashed inputs as the plurality of PoKs.

13. The server computer of any of claims 11 through 12 wherein, as part of activating the multiple PoK provisioning process, the server computer is further operable to receive the assigned password role associated with each of the plurality of stored PoKs.

14. The server computer of claim 13 wherein the assigned password role associated with each of the plurality of stored PoKs is chosen from the group consisting of:
the password role that permits full access to the RP server;
the password role that permits partial access to the RP server;
the password role that permits read-only access to the RP server;
the password role that permits access to the RP server and causes the alert;
the password role that permits the editing of the plurality of stored PoKs;
the password role that permits access to the RP server and causes each other PoK of the plurality of stored PoKs to become suspended; and
a password role that permits access to the RP server but prevents the uploading or creating of new data.

15. The server computer of any of claims 11 through 14 wherein, as part of the multiple PoK provisioning process, the server computer is further operable to:
determine, based on an indication from the client device, whether each input of the plurality of inputs from the client device is acceptable as a PoK;
in response to determining that an input of the plurality of inputs is acceptable as the PoK, proceed to store that input as one of the plurality of PoKs; and
in response to determining that the input of the plurality of inputs is not acceptable as the PoK, refrain from storing that input as one of the plurality of PoKs.

16. The server computer of any of claims 11 through 15 wherein the multiple PoK provisioning process occurs prior to receiving the input from the client device attempting to authenticate with the RP server.

17. The server computer of any of claims 11 through 15 wherein the multiple PoK provisioning process occurs after providing the client device access to the RP server.

18. The server computer of claim 17 wherein the multiple PoK provisioning process occurs in response to receiving a request from the client device to perform password management.

19. The server computer of claim 18 wherein the server computer is further operable to:
in response to receiving the request from the client device to perform password management, send to the client device a status of each of the plurality of PoKs stored, where the status includes one or more of the group consisting of:
a visual reminder of the PoK;
a hint for the PoK;
a number of successful uses of the PoK;
an indication of the last successful use of the PoK;
a password role assigned to the PoK;
an indication of the state of the PoK; and
an indication of the strength of the PoK.

20. A method of operating a server computer providing a Proof of Knowledge (PoK) service, comprising:
receiving an input from a client device attempting to authenticate with a Relying Party (RP) server;
comparing the input to each of a plurality of stored PoKs; and
in response to the input matching at least one of the stored PoKs, providing the client device access to the RP server.
